(19) United States
(12) Patent Application Publication
(10) Pub. No.: US 2014/0127623 A1
(43) Pub. Date: May 8, 2014

(54) LIQUID DEVELOPER AND IMAGE FORMING METHOD

(71) Applicant: KYOCERA DOCUMENT SOLUTIONS INC., Osaka (JP)

(72) Inventor: Toyotsune INOUE, Osaka (JP)

(73) Assignee: KYOCERA DOCUMENT SOLUTIONS INC., Osaka (JP)

(21) Appl. No.: 14/071,436

(22) Filed: Nov. 4, 2013

(30) Foreign Application Priority Data
Nov. 6, 2012 (JP) 2012-244785

(51) Int. Cl. G03G 9/00; G03G 15/10

(52) U.S. Cl. CPC G03G 9/131
USPC 430/112; 399/237

(57) ABSTRACT

A liquid developer includes an insulating carrier liquid, colored particles, an organic macromolecular compound, and a dispersant. The organic macromolecular compound is dissolved in the carrier liquid. The organic macromolecular compound is formed of a copolymer resin selected from cyclic olefin copolymers and styrene-based elastomers. The colored particles are dispersed in the carrier liquid. Each of the colored particles includes a binder resin and carbon black. A mass ratio (V/OP) of a content (V) of the dispersant in the liquid developer to a content (OP) of the organic macromolecular compound in the liquid developer is 0.2 or larger and 0.8 or smaller.

### INCORPORATION BY REFERENCE

The present application claims priority under 35 U.S.C. §119 to Japanese Patent Application No. 2012-244785, filed Nov. 6, 2012. The contents of this application are incorporated herein by reference in their entirety.

### BACKGROUND

The present disclosure relates to liquid developer and image forming methods using the liquid developer.

### BACKGROUND ART

According to the types of developer, electrophotographic development process to visualize an electrostatic latent image with the use of electrostatically charged colored particles is broadly divided into a dry development process and a wet development process in general. Of these processes, the wet development process uses liquid developer in which colored particles are dispersed in an insulating carrier liquid. The colored particles charged in the liquid developer move from the surface of a development roller to the surface of a photosensitive drum in accordance with the principle of electrophoresis, thereby visualizing an electrostatic latent image on the surface of the photosensitive drum. The obtained image is transferred from the photosensitive drum to a recording medium. The colored particles of the liquid developer hardly scatter in the air. This means that fine colored particles can be used which have an average particle diameter of submicron size. Accordingly, a high resolution and high quality image excellent in tone can be obtained.

Heat fixing and optical fixing have been known as schemes for fixing an image formed with the use of the colored particles to a recording medium on the basis of the wet development process. The heat fixing is a scheme in which, where the colored particles are toners of pigments dispersed in a binder resin, heat melts the binder resin to fix the toner to a recording medium. The optical fixing is a scheme in which, where the colored particles are toners of pigments dispersed in a binder resin, a binder resin with a photoreactive functional group is used for photopolymerization, thereby fixing the toner to a recording medium.

However, where the heat fixing or the optical fixing is employed as a scheme for fixing the colored particles to a recording medium, a large amount of thermal energy or optical energy is required for fixing the colored particles to a recording medium. In view of this, in order to save on energy consumption in the wet development process, a liquid developer has been proposed which includes an insulating carrier liquid, colored particles dispersed in the carrier liquid, and an organic macromolecular compound for fixing the colored particles to a recording medium. The significant features of this liquid developer lie in that the organic macromolecular compound is dissolved in the carrier liquid, and the colored particles are pigment.

### SUMMARY

The present disclosure provides the followings.

The first aspect of the present disclosure is a liquid developer, which includes an insulating carrier liquid, colored particles, an organic macromolecular compound, and a dispersant. The organic macromolecular compound is dissolved in the carrier liquid. The organic macromolecular compound is formed of a copolymer resin selected from cyclic olefin copolymers and styrene-based elastomers. The colored particles are dispersed in the carrier liquid. Each of the colored particles includes a binder resin and carbon black. A mass ratio (V/OP) of a content (V) of the dispersant in the liquid developer to a content (OP) of the organic macromolecular compound in the liquid developer is 0.2 or larger and 0.8 or smaller.

The second aspect of the present disclosure is an image forming method. The image forming method employs a wet development process which includes: electrostatically charging a surface of a photosensitive drum; exposing the electrostatically charged surface of the photosensitive drum to form an electrostatic latent image on the surface of the photosensitive drum; developing the electrostatic latent image on the surface of the photosensitive drum with the use of the liquid developer in the first aspect; transferring the developed image to a recording medium; and ejecting the recording medium to which the image is transferred to an ejection section.

### BRIEF DESCRIPTION OF THE DRAWINGS

FIG. 1 is a diagram of an image forming apparatus employing a wet development process, which is used in the second embodiment of the present disclosure.

FIG. 2 is a diagram for explaining a liquid development device included in the image forming apparatus employing the wet development process, which is shown in FIG. 1, and its vicinity.

### DETAILED DESCRIPTION

Embodiments of the present disclosure will be described in detail below. However, the present disclosure is not limited to the following embodiments and can be reduced in practice with any appropriate modifications within the scope of the purpose of the present disclosure. It is noted that description of parts about which description is duplicate may be omitted appropriately. However, this should not be taken to limit the disclosure.

### First Embodiment

The first embodiment of the present disclosure pertains to a liquid developer. The liquid developer according to the first embodiment incudes an insulating carrier liquid, colored particles, an organic macromolecular compound, and a dispersant. The organic macromolecular compound is dissolved in the carrier liquid and is formed of a copolymer resin selected from cyclic olefin copolymers and styrene-based elastomers. The colored particles are dispersed in the carrier liquid and include a binder resin and carbon black. The mass ratio (V/OP) of the content (V) of the dispersant in the liquid developer to the content (OP) of the organic macromolecular compound in the liquid developer is 0.2 or larger and 0.8 or smaller.

Depending on a combination of the binder resin included in the colored particles and the carrier liquid, a slight amount of the binder resin may be dissolved in the carrier liquid. However, such a state is excluded from a state in which the organic macromolecular compound is dissolved in the carrier liquid in the present disclosure. The state in which the organic macromolecular compound is dissolved in the carrier liquid means the state in which the organic macromolecular compound different from the binder resin included in colored particles is dissolved in the carrier liquid to the amount that can achieve the purpose of the present disclosure.

Further, in the present disclosure, depending on an environment or a condition, such as temperature variation and variation in a condition for manufacturing the liquid developer, the liquid developer may inevitably contain an organic macromolecular compound that is not dissolved in the carrier liquid. However, inevitable containing of such an organic macromolecular compound that is not dissolved in the carrier liquid in the liquid developer is permitted within the range not adversely affecting the present disclosure. Specifically, the words, inevitable content of an organic macromolecular compound that is not dissolved in the carrier liquid in the liquid developer means that the amount of the organic macromolecular compound that is not dissolved in the carrier liquid is 10 mass % or lower, and more preferably 5 mass % or lower relative to the total mass of the organic macromolecular compound.

Description will be made below about the carrier liquid, the colored particles, the organic macromolecular compound, the dispersant, and a method for preparing the liquid developer according to the first embodiment in this order.

### [Carrier Liquid]

As the carrier liquid included in the liquid developer, an organic solvent of an insulating liquid is used in general. The carrier liquid serves as a liquid carrier and is used for the purpose of enhancing electrically insulating property of the obtained liquid developer. The volume resistance of the insulating carrier liquid at a temperature of 25° C. is preferably 10¹⁰ Ω·cm or larger, and more preferably 10¹² Ω·cm or larger.

Examples of an organic solvent as a liquid that can be suitably used as the insulating carrier liquid include aliphatic hydrocarbons in a liquid state at the normal temperature, such as n-paraffin-based hydrocarbons, iso-paraffin-based hydrocarbons, halogenated aliphatic hydrocarbons, and mixtures of them. The aliphatic hydrocarbons in a liquid state at the normal temperature may be in a straight chain or a branched chain. Specific examples of the aliphatic hydrocarbons in a liquid state at the normal temperature include n-hexane, n-heptane, n-octane, nonane, decane, dodecane, hexadecane, heptadecane, cyclohexane, perchloroethylene, and trichloroethane.

Incidentally, a recent demand in various products is to reduce the amount of volatilization of organic compounds by reducing the content of volatile organic compounds (VOC). In view of this, an organic solvent having relatively low volatility is favorable as the carrier liquid. The organic solvent having relatively low volatility means an organic solvent with a boiling point of 200° C. or higher. Specific examples of such an organic solvent with a high boiling point include hydrocarbon compounds in which a aliphatic hydrocarbon with 16 or more carbon atoms is much contained (e.g., liquid paraffin).

The carrier liquid may be commercially available one or prepared one. The prepared organic solvent means a mixture of a plurality of organic solvents. Specific examples of the organic solvents that can be suitably used as the carrier liquid include: “Isopar™ G”, “Isopar™ H”, “Isopar™ K”, “Isopar™ L”, “Isopar™ M”, and “Isopar™ V” by Exxon Mobil Corporation; “MORESCO WHITE™ P-40”, “MORESCO WHITE™ P-55”, “MORESCO WHITE™ P-70”, and “MORESCO WHITE™ P-200” as liquid paraffin by MORESCO CORPORATION; and “COSMO WHITE P-60”, “COSMO WHITE P-70”, and “COSMO WHITE P-120” as liquid paraffin by COSMO OIL CO., LTD.

### [Colored Particles]

The liquid developer includes colored particles each including a binder resin and carbon black. Each of the colored particles may include a charge control agent for the purpose of increasing the charge level of the colored particles, for example. The content of the colored particles in the liquid developer may be preferably 5 mass % or higher and 40 mass % or lower, and more preferably 10 mass % or higher and 30 mass % or lower relative to the total mass of the liquid developer. The binder resin, the carbon black, the charge control agent, and a method for producing the colored particles will be described below sequentially.

### (Binder Resin)

The binder resin included in the colored particles is not particularly limited as long as it is not dissolved or is slightly dissolved in the carrier liquid and can maintain the state in which the carbon black is dispersed in the binder resin. Such a binder resin can be appropriately selected for use from binder resins used in toner particles included in generally used liquid developer.

Specific examples of a suitable binder resin include thermoplastic resins, such as styrene-based resin, acrylic resin, styrene-acrylic copolymer, polyethylene-based resin, polypropylene-based resin, vinyl chloride-based resin, polyester resin, polyamide resin, polyurethane resin, polyvinyl alcohol-based resin, vinyl ether-based resin, and N-vinyl-based resin. Of these types of resins, polyester resin is preferable in view of dispersibility of carbon black in the colored particles, electrification characteristics of the colored particles, and fixability to a recording medium. It is noted that according to the types of the carrier liquid, polyethylene-based resin and polypropylene-based resin with too low molecular weights may tend to be dissolved in the carrier liquid. For this reason, where polyethylene-based resin or polypropylene-based resin is used as the binder resin, the solubility of the binder resin in the carrier liquid should be checked before preparation of the liquid developer.

### (Carbon Black)

Each of the colored particles include carbon black as colorant. Each of the colored particles may include carbon black and known black pigment in combination for the purpose of adjustment of the colored particles to a desired color phase. Examples of the black pigment that can be added to each of colored particles other than carbon black include acetylene black, lampblack, and aniline black. Two or more types of black pigment other than carbon black may be used in combination.

The amount of use of the carbon black is preferably 5 parts by mass or more and 400 parts by mass or less, and more preferably 40 parts by mass or more and 150 parts by mass or less relative to the binder resin of 100 parts by mass of the binder resin.

### (Charge Control Agent)

Each of the colored particles may include a charge control agent for the purpose of increasing the charge level of the colored particles. Where the colored particles are positively charged for development, a positively chargeable charge control agent is used. Where the colored particles are negatively charged for development, a negatively chargeable charge control agent is used.

The type of the charge control agent can be appropriately selected from generally used charge control agents. Specific examples of the positively chargeable charge control agent include: azine compounds, such as pyridazine, pyrimidine, pyrazine, ortho-oxazine, meta-oxazine, para-oxazine, ortho-thiazine, meta-thiazine, para-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes made of an azine compound, such as azine fast red FC, azine fast red 12BK, azine violet BO, azine brown 3G, azine light brown GR, azine dark green BH/C, azine deep black EW, and azine deep black 3RL; nigrosine compounds, such as nigrosine, nigrosine salts, nigrosine derivatives; acid dyes made of a nigrosine compound, such as nigrosine BK, nigrosine NB, and nigrosine Z; metal salts of naphthenic acids or higher fatty acids; alkoxylated amine; alkylamide; and quaternary ammonium salts, such as benzylmethylhexyldecylammonium, and decyltrimethylammonium chloride. Two or more of these positively chargeable charge control agents can be used in combination.

Resins with a quaternary ammonium salt, a carboxylate salt, or a carboxyl group as a functional group may be used as the positively chargeable charge control agent. More specific examples include a styrene-based resin with a quaternary ammonium salt, an acrylic resin with a quaternary ammonium salt, a styrene-acrylic resin with a quaternary ammonium salt, a polyester resin with a quaternary ammonium salt, a styrene-based resin with an carboxylate salt, an acrylic resin with a carboxylate salt, a styrene-acrylic resin with a carboxylate salt, a polyester resin with a carboxylate salt, a styrene-based resin with a carboxyl group, an acrylic resin with a carboxyl group, a styrene-acrylic resin with a carboxyl group, and a polyester resin with a carboxyl group. The molecular weight of these types of resins is not particularly limited within a range not adversely affecting the present disclosure. These types of resins may be an oligomer or a polymer.

Specific examples of the negatively chargeable charge control agent include organometallic complexes and chelate compounds. Preferable examples as the organometallic complexes and the chelate compounds may be: acetylacetone metal complexes, such as aluminum acetylacetonate and iron(II) acetylacetonate; and salicylic acid-based metal complexes or salicylic acid-based metal salts, such as chromium 3,5-di-tert-butylsalicylate. Among the negatively chargeable charge control agents, salicylic acid-based metal complexes and salicylic acid-based metal salts are preferable. Two or more of the negatively charged charge control agents may be used in combination.

The amount of use of the positively or negatively chargeable charge control agent is preferably 1.5 parts by mass or more and 15 parts by mass or less, more preferably 2.0 parts by mass or more and 8.0 parts by mass or less, and particularly preferably 3.0 parts by mass or more and 7.0 parts by mass or less relative to 100 parts by mass of the binder resin.

### (Method for Producing Colored Particles)

The method for producing the colored particles is not particularly limited within the scope not adversely affecting the present disclosure. The colored particles can be produced similarly to production of toner particles generally included in the liquid developer. A specific example of a suitable method for producing the colored particles may be a method in which the binder resin and carbon black, and the charge control agent if desired, are mixed using a mixer and melted and kneaded using a kneading machine, such as an extruder, and then, the kneaded substance is cooled, crushed, and classified. In general, the average particle diameter of the colored particles after crushing and classification is preferably 2 μm or larger and 10 μm or smaller, and more preferably 4 μm or larger and 8 μm or smaller. Further, the crushed and classified colored particles are generally mixed and dispersed together with carrier liquid by a mixer, such as a ball mill before preparation of the liquid developer. The obtained liquid is used as a concentrated developer for preparation of a liquid developer. The average particle diameter of the colored particles in the concentrated developer in such a case is preferably 0.1 μm or larger and 1.5 μm or smaller, and more preferably 0.2 μm or larger and 1.3 μm or smaller.

### [Organic Macromolecule Compound]

The liquid developer includes an organic macromolecular compound in a state in which it is dissolved in the carrier liquid. Where the liquid developer includes an organic macromolecular compound in a state in which it is dissolved in the carrier liquid, penetration into a recording medium and drying of the carrier liquid may accompany an increase in concentration of the organic macromolecular compound in the carrier liquid on the surface of the recording medium. When the concentration of the organic macromolecular compound in the carrier liquid exceeds the saturated solubility, a film of the organic macromolecular compound is formed on the surfaces of the colored particles on the recording medium. This can advance fixation of the colored particles to the recording medium.

The content (OP) of the organic macromolecular compound in the liquid developer is not particularly limited as long as the mass ratio (V/OP) of the content (V) of the dispersant in the liquid developer to the content (OP) of the organic macromolecular compound in the liquid developer is 0.2 or larger and 0.8 or smaller. The content (OP) of the organic macromolecular compound in the liquid developer is preferably 1 mass % or higher and 10 mass % or lower, more preferably 2 mass % or higher and 8 mass % or lower, and particularly preferably 4 mass % or higher and 6 mass % or lower.

Too low content of the organic macromolecular compound may reduce the amount of the film of the organic macromolecular compound retained on a recording medium. For this reason, the film of the organic macromolecular compound may be difficult to be formed on the colored particles, which may result in reduction in fixability. By contrast, too high content of the organic macromolecular compound may increase the amount of the film of the organic macromolecular compound retained on the surface of a recording medium, which may result in difficulty in drying of the film. For this reason, where the content of the organic macromolecular compound is too high, the viscosity (stickiness) of the film may increase excessively to significantly impair the abrasion resistance of an image.

The molecular weight of the organic macromolecular compound is preferably 10,000 or more and 300,000 or less as a weight average molecular weight. The use of the organic macromolecular compound with a molecular weight within such a range can achieve more favorable fixing of the colored particles to a recording medium. A gel permeation chromatography (GPC) can measure the molecular weight of the organic macromolecular compound.

The organic macromolecular compound is formed of a copolymer resin selected from cyclic olefin copolymers and styrene-based elastomers. Cyclic olefin copolymers and styrene-based elastomers are excellent in solubility in the carrier liquid. Inclusion of the copolymer resin selected from cyclic olefin copolymers and styrene-based elastomers in the liquid developer can achieve favorable image fixing even in fixing an image without providing energy as in a scheme, such as heating for fixing. The cyclic olefin copolymers and the styrene-based elastomers will be described below sequentially.

### (Cyclic Olefin Copolymer)

The cyclic olefin copolymers are macromolecule compounds having a main chain of a carbon-carbon bond, which has a cyclic hydrocarbon structure at least in part. The cyclic hydrocarbon structure can be introduced by using, as a monomer, a compound (cyclic olefin) having at least one olefinic double bond in the cyclic hydrocarbon structure, such as norbornene and tetracyclododecene.

Examples of a cyclic olefin copolymer that can be suitably used include: (1) addition (co)polymers of a cyclic olefin or their hydrogenated products; (2) addition copolymers of a cyclic olefin and an α-olefin or their hydrogenated products; and (3) cyclic olefin ring opening (co)polymers or their hydrogenated products.

Specific examples of a cyclic olefin used as a monomer of the cyclic olefin copolymers include the followings, (a) to (k). That is:

(a) cyclopentene, cyclohexene, cyclooctene;
(b) monocyclic olefins, such as cyclopentadiene and 1,3-cyclohexadiene;
(c) bi-cyclic olefins, such as bicyclo[2.2.1]hept-2-ene (norbornene), 5-methyl-bicyclo[2.2.1]hept-2-ene, 5,5-dimethyl-bicyclo[2.2.1]hept-2-ene, 5-ethyl-bicyclo[2.2.1]hept-2-ene, 5-butyl-bicyclo[2.2.1]hept-2-ene, 5-ethylidene-bicyclo[2.2.1]hept-2-ene, 5-hexyl-bicyclo[2.2.1]hept-2-ene, 5-octyl-bicyclo[2.2.1]hept-2-ene, 5-octadecyl-bicyclo[2.2.1]hept-2-ene, 5-methylidene-bicyclo[2.2.1]hept-2-ene, 5-vinyl-bicyclo[2.2.1]hept-2-ene, and 5-propenyl-bicyclo[2.2.1]hept-2-ene;
(d) tricyclo[4.3.0.1^{2,5}]dec-3,7-diene (dicyclopentadiene) and tricyclo[4.3.0.1^{2,5}]dec-3-ene;
(e) tricyclo[4.4.0.1^{2,5}]undeca-3,7-diene and tricyclo[4.4.0.1^{2,5}]undeca-3,8-diene, and tricyclo[4.4.0.1^{2,5}]undeca-3-ene as a partially hydrogenated product thereof (or an adduct of cyclopentadiene and cyclohexene);
(f) tri-cyclic olefins, such as 5-cyclopentyl-bicyclo[2.2.1]hept-2-ene, 5-cyclohexyl-bicyclo[2.2.1]hept-2-ene, 5-cyclohexenyl-bicyclo[2.2.1]hept-2-ene, and 5-phenyl-bicyclo[2.2.1]hept-2-ene;
(g) tetra-cyclic olefins, such as tetracyclo[4.4.0.1^{2,5}.1^{7,}1⁰]dodec-3-ene (tetracyclododecene), 8-methyltetracyclo[4.4.0.1^{2,5}.1^{7,}1⁰]dodec-3-ene, 8-ethyltetracyclo[4.4.0.1^{2,5}.1^{7,}1⁰]dodec-3-ene, 8-methylidenetetracyclo[4.4.0.1^{2,5}.1^{7,}1⁰]dodec-3-ene, 8-ethylidenetetracyclo[4.4.0.1^{2,5}.1^{7,}1⁰]dodec-3-ene, 8-vinyltetracyclo[4.4.0.1^{2,5}.1^{7,}1⁰]dodec-3-ene, and 8-propenyl-tetracyclo[4.4.0.1^{2,5}.1^{7,}1⁰]dodec-3-ene;
(h) 8-cyclopentyl-tetracyclo[4.4.0.1^{2,5}.1^{7,}1⁰]dodec-3-ene, 8-cyclohexyl-tetracyclo[4.4.0.1^{2,5}.1^{7,}1⁰]dodec-3-ene, 8-cyclohexenyl-tetracyclo[4.4.0.1^{2,5}.1^{7,}1⁰]dodec-3-ene, and 8-phenyl-cyclopentyl-tetracyclo[4.4.0.1^{2,5}.1^{7,}1⁰]dodec-3-ene;
(i)
tetracyclo[7.4.1^{3,6}.0^{1,9}.0^{2,7}]tetradeca-4,9,11,13-tetraene(1,4-methano-1,4,4a,9a-tetrahydrofluorene), tetracyclo[8.4.1^{4,7}.0^{1,1}.0^{3,8}]pentadeca-5,10,12,14-tetraene (1,4-methano-1,4,4a,5,10,10a-hexahydroanthracene);
(j) pentacyclo[6.6.1.1^{3,6}.0^{2,7}.0^{9,14}]-4-hexadecene, pentacyclo[6.5.1.1^{3,6}.0^{2,7}.0^{9,13}]-4-pentadecene, pentacyclo[7.4.0.0^{2,7}. 1^{3,6}.11^{0,13}]-4-pentadecene, heptacyclo[8.7.0.1^{2,9}.0^{3,8}.1^{4,7}.01^{2,17}.11^{3,16}]-14-eicosene, and heptacyclo[8.7.0.1^{2,9}.0^{3,8}.1^{4,7}.01^{2,17}. 11^{3,16}]-14-eicosene; and
(k) polycyclic olefins, such as a tetramer of cyclopentadiene. These cyclic olefins can be used solely or in combination of two or more.

As an α-olefin for copolymerization with the cyclic olefin, an α-olefin with 2 to 20 carbon atoms is preferable. Yet, an α-olefin with 2 to 8 carbon atoms is more preferable. Specific examples of a suitably used α-olefin include monomers, such as ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, and 1-eicosene. These α-olefins can be used solely or in combination of two or more.

Methods for polymerizing the cyclic olefin, for copolymerizing the cyclic olefin with the α-olefin, and for hydrogenating an obtained polymer in producing a cyclic olefin copolymer are not limited within the scope not adversely affecting the present disclosure. These methods can be appropriately selected from any known methods.

The structure of the molecular chain of the cyclic olefin copolymer is not particularly limited within the scope not adversely affecting the present disclosure. The structure of the molecular chain of the cyclic olefin copolymer may be in a straight chain or a branched chain, or cross-linked. Of these structures, the straight chain is preferable in view of the fact that a cyclic olefin copolymer is readily dissolved in the carrier liquid.

Among the aforementioned cyclic olefin copolymers, a copolymer of norbornene and ethylene and a copolymer of tetracyclododecene and ethylene are preferable. In particular, the copolymer of norbornene and ethylene is more preferable. The content by percentage of norbornene in the copolymer of norbornene and ethylene is preferably 60 mass % or higher and 82 mass % or lower, more preferably 60 mass % or higher and 79 mass % or lower, yet more preferably 60 mass % or higher and 76 mass % or lower, and the most preferably 60 mass % or higher and 65 mass % or lower. Too low content by percentage of norbornene in the copolymer of norbornene and ethylene may invite too low glass transition temperature of a film of the cyclic olefin copolymer. This may result in difficulty in formation of the film of the cyclic olefin copolymer on the colored particles in fixing an image, thereby impairing fixability. Too high content by percentage of norbornene in the copolymer of norbornene and ethylene may invite too low solubility of the cyclic olefin copolymer in the carrier liquid.

Any of commercially available ones and synthetic ones can be used as the cyclic olefin copolymer. Examples of the commercially available cyclic olefin copolymer include the followings. That is, examples as the copolymer of norbornene and ethylene include “TOPAS (registered trademark) TM” (content by percentage of norbornene: about 60 mass %, glass transition temperature: about 60° C.), “TOPAS (registered trademark) TB” (content by percentage of norbornene: about 60 mass %, glass transition temperature: about 60° C.), “TOPAS (registered trademark) 8007” (content by percentage of norbornene: about 65 mass %, glass transition temperature: about 80° C.), “TOPAS (registered trademark) 5013” (content by percentage of norbornene: about 76 mass %, glass transition temperature: about 140° C.), “TOPAS (registered trademark) 6013” (content by percentage of norbornene: about 76 mass %, glass transition temperature: about 140° C.), “TOPAS (registered trademark) 6015” (content by percentage of norbornene: about 79 mass %, glass transition temperature: about 160° C.), and “TOPAS (registered trademark) 6017” (content by percentage of norbornene: about 82 mass %, glass transition temperature: about 180° C.), all of which are products by TOPAS Advanced Polymers GmbH.

### (Styrene-Based Elastomer)

A styrene-based elastomer appropriately selected from any known styrene-based elastomers can be used within the scope not adversely affecting the present disclosure. Specific examples of the styrene-based elastomer include block copolymers of an aromatic vinyl compound and an olefin-based compound or a conjugated diene compound. One example of the block copolymers may be a block copolymer expressed by the following formula (1). The block copolymer expressed by the following formula (1) includes a polymer block A derived from an aromatic vinyl compound and a polymer block B derived from an olefin-based compound or a conjugated diene compound.

[A-B]ₓ-A (1)

wherein x is an integer. The number average molecular weight of the block copolymer expressed by the formula (1) is 1,000 or larger and 100,000 or smaller.

Examples of the aromatic vinyl compound forming the polymer block A included in the block copolymer expressed by the formula (1) include compounds, such as styrene, α-methylstyrene, o-methylstyrene, m-methylstyrene, p-methylstyrene, 2,3-dimethyl styrene, 2,4-dimethylstyrene, monochlorostyrene, dichlorostyrene, p-bromostyrene, 2,4,5-tribromostyrene, 2,4,6-tribromostyrene, o-tert-butylstyrene, m-tert-butylstyrene, p-tert-butylstyrene, ethylstyrene, vinylnaphthalene, and vinylanthracene. The polymer block A may be one derived from one type of aromatic vinyl compound. The polymer block A may be one derived from two or more types of aromatic vinyl compounds. The styrene-based elastomer is preferably one including a polymer block A derived from styrene and/or α-methylstyrene.

Examples of the olefin-based compound forming the polymer block B contained in the block copolymer expressed by the formula (1) include compounds, such as ethylene, propylene, 1-butene, 2-butene, isobutene, 1-pentene, 2-pentene, cyclopentene, 1-hexene, 2-hexene, cyclohexene, 1-heptene, 2-heptene, cycloheptene, 1-octene, 2-octene, cyclooctene, vinylcyclopentene, vinylcyclohexene, vinylcycloheptene, and vinylcyclooctene. Further, examples of the conjugated diene compound include compounds, such as butadiene, isoprene, chloroprene, 2,3-dimethyl-1,3-butadiene, 1,3-pentadiene, and 1,3-hexadiene. The polymer block B may be one derived from one type of compound selected from the olefin-based compounds and the conjugated diene compounds. The polymer block B may be one derived from two or more types of compounds selected from the olefin-based compounds and the conjugated diene compounds. The styrene-based elastomer is preferably one including a polymer block B derived from butadiene and/or isoprene.

Of the styrene-based elastomers, a styrene-butadiene-based elastomer (SBS) expressed by the following formula (2) is preferable. The styrene-butadiene-based elastomer (SBS) expressed by the following formula (2) is formed of a polymer block A and a polymer block B.

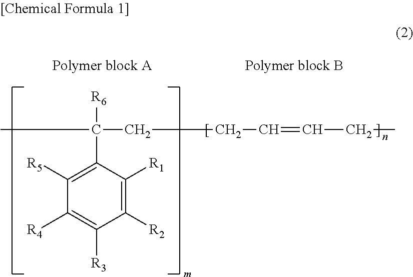

wherein references R₁, R₂, R₄, R₅, and R₆ are each independently a hydrogen atom or a methyl group; reference R₃ is a hydrogen atom, a saturated alkyl group with 1 to 20 carbon atoms, a methoxy group, an ethoxy group, a phenyl group, or a halogen atom; and reference m and n are integers. The amount of the polymer block A included in the styrene-butadiene-based elastomer is 5 mass % or higher and 75 mass % or lower.

The styrene-butadiene-based elastomer can be obtained by copolymerization of a styrene-based monomer and butadiene as a conjugated diene compound. Specific examples of the styrene-based monomer include monomers, such as styrene, α-methylstyrene, o-methylstyrene, m-methylstyrene, p-methylstyrene, p-ethylstyrene, 2,4-dimethylstyrene, p-n-butylstyrene, p-dodecylstyrene, p-methoxystyrene, p-phenylstyrene, and p-chlorostyrene.

The amount of styrene contained in the styrene-butadiene-based elastomer (content of the polymer block A) is preferably 5 mass % or higher and 75 mass % or lower, and more preferably 10 mass % or higher and 65 mass % or lower. Too low content of styrene in the styrene-butadiene-based elastomer may invite too low glass transition temperature of the film of the styrene-butadiene-based elastomer. This may lead to difficulty in forming the film of the styrene-butadiene-based elastomer on the colored particles in fixing the colored particles to a recording medium. Too high content of styrene contained in the styrene-butadiene-based elastomer may invite too high softening temperature of the film of the styrene-butadiene-based elastomer. This may reduce the fixability of the colored particles to a recording medium, which is caused due to the presence of the film of the styrene-based elastomer. That is, the fixability of an image may be impaired.

The styrene-based elastomer may be any of commercially available ones and synthesized ones. Examples of the commercially available styrene-based elastomers as styrene-conjugated diene block copolymers include, for example, “SEPTON” and “HYBRAR” by KURARAY CO., LTD., “Kraton” by Shell Japan Ltd., “Asaprene (registered trademark)” and “Tufprene (registered trademark)” by Asahi Kasei Chemicals Corp., and “DYNARON” by JSR Corporation. One example of the commercially available styrene-based elastomer as a styrene-ethylene copolymer includes, for example, “INDEX” by The Dow Chemical Company. As the commercially available styrene-based elastomer, a composition of styrene-based elastomer may be used, such as “ARON AR” by ARONKASEI CO., LTD. and “RABALON” by Mitsubishi Chemical Corporation. Two or more types of the above styrene-based elastomers may be used in combination.

### [Dispersant]

The liquid developer according to the first embodiment includes a dispersant. Where the liquid developer includes a dispersant, the colored particles can be favorably dispersed in the liquid developer. Accordingly, the particle diameter of the colored particles in the liquid developer can be adjusted to a desired particle diameter. The dispersant covering carbon black exposed to the surface of the colored particles can reduce discharge from the carbon black. Accordingly, with the liquid developer including the dispersant, the colored particles can be easily charged to a desired charge amount, thereby achieving easy formation of an image with desired image density.

The dispersant is not particularly limited as long as it can favorably disperse the colored particles in the liquid developer. The dispersant can be appropriately selected from various dispersants generally used as a dispersant for colored particles and pigment. Any of commercially available ones and synthesized ones can be used as the dispersant.

Examples of the dispersant include hydroxyl group containing carboxylate esters, salts of long chain polyaminoamides and high molecular weight acid esters, salts of high molecular weight polycarboxylic acids, high molecular weight unsaturated acid esters, polymeric copolymers, modified polyacrylates, aliphatic polycarboxylic acids, naphthalenesulfonic acid-formaldehyde condensates, polyoxyethylene alkyl ether phosphate esters, pigment derivatives, and macromolecule dispersants.

Examples of suitable commercially available dispersants include: “BYK-116” by BYK Japan KK; “SOLSPERSE 9000”, “SOLSPERSE 11200”, “SOLSPERSE 13940”, “SOLSPERSE 16000”, “SOLSPERSE 17000” and “SOLSPERSE 18000” by Lubrizol Japan Limited; and “Antaron (registered trademark) V-216” and “Antaron (registered trademark) V-220” by ISP Japan Ltd.

The content (V) of the dispersant in the liquid developer is not particularly limited as long as the mass ratio (V/OP) of the content (V) of the dispersant in the liquid developer to the content (OP) of the organic macromolecular compound in the liquid developer is 0.2 or larger and 0.8 or smaller. The content (V) of the dispersant in the liquid developer is preferably 0.5 mass % or higher and 10 mass % or lower, and more preferably 1 mass % or higher and 6 mass % or lower.

Too low content of the dispersant in the liquid developer may cause difficulty in adjusting the particle diameter of the colored particles in the liquid developer to a desired particle diameter. Also, too low content of the dispersant may cause difficulty in reducing discharge from the carbon black exposed to the surfaces of the colored particles. Accordingly, the charge state of the colored particles may tend to be unstable to cause difficulty in forming an image with desired image density on a recording medium. By contrast, too high content of the dispersant in the liquid developer may inhibit the film of the organic macromolecular compound from being formed on the colored particles in fixing the colored particles to a recording medium. Accordingly, where the content of the dispersant in the liquid developer is too high, the colored particles may be unfavorably fixed to a recording medium.

It is noted that the particle diameter of the colored particles in the liquid developer can be adjusted to a desired value by using a device capable of high emulsification and dispersion, such as a high pressure homogenizer, even without using a dispersant. Examples of the high pressure homogenizer include Nanomizer (by YOSHIDA KIKAI CO., LTD.), Ultimaizer (by SUGINO MACHINE LIMITED), NANO 3000 (by Sojitz Machinery Corporation), Microfluidizer (by MIZUHO Industrial CO., LTD.), and Homogenizer (by SANWA ENGINEERING CO., LTD.). However, where the liquid developer according to the first embodiment of the present disclosure includes no dispersant, it may be difficult to reduce discharge from the carbon black expose to the surfaces of the above colored particles, which may tend to make the colored particles to be in an unstable charge state. This may cause difficulty in formation of an image with desired image density on a recording medium.

### [Method for Preparing Liquid Developer]

One example of a suitable method for preparing the liquid developer may be a method in which a concentrated developer as a concentrated dispersion solution of the colored particles including the colored particles and the carrier liquid and an organic macromolecular compound solution as an organic solvent solution of the organic macromolecular compound are prepared beforehand, and then, the concentrated developer, the organic macromolecular compound solution, and the carrier liquid are mixed using a homomixer.

One example of a suitable method for preparing the concentrated developer may be a method in which the carrier liquid and the colored particles are dispersed and mixed in the presence of the dispersant by using a device capable of mixing the carrier liquid and the colored particles and dispersing the colored particles, such as a ball mill.

The organic solvent used in preparation of the organic macromolecular compound solution may be appropriately selected according to the types of the organic macromolecular compound. In general, a carrier liquid is used as the organic solvent. It is noted that where the organic macromolecular compound is slightly difficult to be dissolved in the carrier liquid, like an styrene-based elastomer, an organic solvent for dissolving the organic macromolecular compound may be used, such as fatty acid esters, ketones, aromatic hydrocarbons, and vegetable oils. More specific examples of the organic solvent include: aromatic solvents, such as styrene, benzene, toluene, xylene, and ethylbenzene; chlorinated hydrocarbons, such as 2,2-dichloropropane, 1,2-dichloropropane, chloroform, trichloroethylene, tetrachloroethylene, chlorobenzene, methylene chloride, and ethylene dichloride; ketones, such as diisobutyl ketone, diisopropyl ketone, methyl isobutyl ketone, methyl amyl ketone, methyl propyl ketone, diethyl ketone, methyl ethyl ketone, cyclohexanone, acetone, and cyclopentanone; esters, such as isobutyl n-butyrate, isopropyl isobutyrate, methylamyl acetate, butyl butyrate, isopropyl acetate, amyl acetate, butyl acetate, cellosolve acetate, propyl acetate, ethyl acetate, and methyl acetate; ethers, such as diethyl ether, dimethyl ether, dichloro ethyl ether, dioxane, and tetrahydrofuran; alcohols, such as methanol, ethanol, n-propanol, isopropanol, n-butanol, n-pentanol, n-hexanol, cyclohexanol, diethylene glycol, and glycerol. Two or more of these organic solvents may be used in combination.

Where the organic macromolecular compound is hard to be dissolved in preparing the organic macromolecular compound solution, a mixture of the organic solvent and the organic macromolecular compound may be heated. Further, in preparing the organic macromolecular compound solution, the larger the amount of the organic solvent is, the more readily the organic macromolecular compound is dissolved, and the more easily the organic macromolecular compound solution can be prepared. In this case, a dilute organic macromolecular compound solution may be concentrated within the range that can maintain the solution state.

In the liquid developer prepared as above, the mass ratio (V/OP) of the content (V) of the dispersant in the liquid developer to the content (OP) of the organic macromolecular compound in the liquid developer is 0.2 or larger and 0.8 or smaller. In the liquid developer according to the first embodiment, the liquid developer includes the organic macromolecular compound and the dispersant so that V/OP is 0.2 or larger and 0.8 or smaller. This can achieve formation of an image with desired image density to a recording medium, while reducing consumption of thermal energy or optical energy in fixing the colored particles to a recording medium. Also, the colored particles can be favorably fixed to a recording medium.

Where V/OP is too large, less OP may cause difficulty in formation of the film of the organic macromolecular compound on the colored particles. Further, much V may tend to inhibit the film of the organic macromolecular compound from being formed on the colored particles in fixing the colored particles to a recording medium. For this reason, where the content of the dispersant is too much, it may be difficult to favorably fix the colored particles to a recording medium.

By contrast, where V/OP is too small, the viscosity (stickiness) of the film may increase excessively. Accordingly, where V/OP is too small, the abrasion resistance of an image may be impaired significantly. Further, in this case, it is difficult to reduce discharge from the carbon black exposed to the surfaces of the colored particles. Thus, where V/OP is too small, the charge state of the colored particles may tend to be unstable to cause difficulty in formation of an image with desired image density on a recording medium.

Thus, the above described liquid developer of the first embodiment can achieve formation of an image with desired image density on a recording medium, while reducing consumption of thermal energy or optical energy in fixing the colored particles to a recording medium. Also, the colored particles can be favorably fixed to a recording medium. Accordingly, the liquid developer according to the first embodiment can be suitably used in various image forming apparatuses of wet development type.

### Second Embodiment

The second embodiment of the present disclosure pertains to an electrophotographic image forming method by a wet development process. The image forming method according to the second embodiment uses the liquid developer according to the first embodiment. The image forming method according to the second embodiment includes: electrostatically charging a surface of a photosensitive drum; exposing the electrostatically charged surface of the photosensitive drum to form an electrostatic latent image on the surface of the photosensitive drum; developing the electrostatic latent image on the surface of the photosensitive drum with the use of the liquid developer according to the present disclosure; transferring the developed image to a recording medium; and ejecting the recording medium to which the image is transferred to an ejection section. With reference to the accompanying drawings, description will be made below about the image forming method using a monochrome printer employing the wet development process as an image forming apparatus.

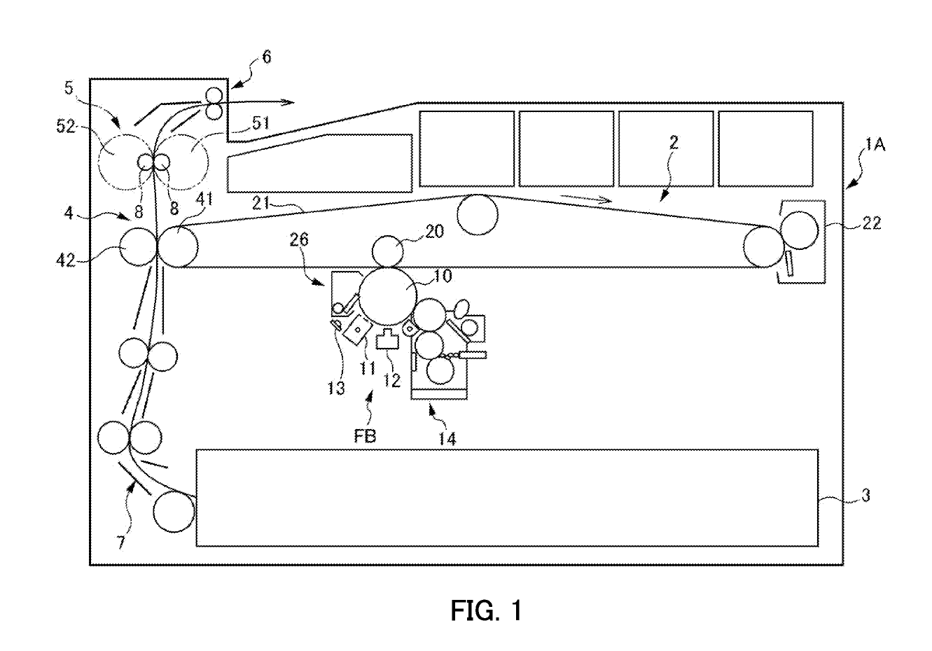

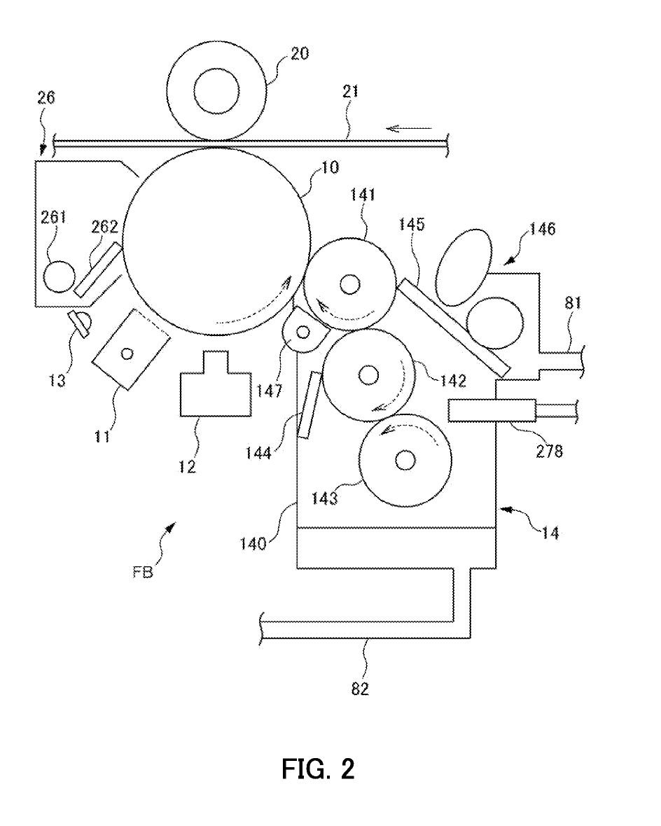

FIG. 1 is a diagram of a wet type image forming apparatus used for forming an image with the use of the liquid developer according to the present disclosure. FIG. 2 is a diagram for explaining a liquid development device that the wet type image forming apparatus in FIG. 1 incudes and its vicinity. It is noted that the image forming method will be described by reference to a monochrome printer as an example. The image forming method using the liquid developer according to the first embodiment of the present disclosure is also applicable to copiers, facsimile machines, image forming apparatuses having these functions, such as multifunction peripherals, and any other wet type image forming apparatuses capable of forming an image on a recording medium.

A wet type image forming apparatus 1A in FIG. 1 is used in the image forming method using the liquid developer of the present disclosure. As shown in FIG. 1, the wet type image forming apparatus 1A accommodates various units and components for image formation. Although the image forming apparatus 1A further accommodates a black (Bk) liquid developer circulating device below the part shown in FIG. 1, it is not shown.

The wet type image forming apparatus 1A includes an image forming section 2, a recording medium accommodating section 3, a secondary transfer section 4, an ejection section 6, and a recording medium conveyance section 7. The image forming section 2 forms an image on the basis of image data. The recording medium accommodating section 3 accommodates a recording medium. The secondary transfer section 4 transfers the image formed in the image forming section 2 to a recording medium. The ejection section 6 ejects the recording medium, to which the image has been transferred, to the exterior of the apparatus. The recording medium conveyance section 7 conveys a recording medium from the recording medium accommodating section 3 to the ejection section 6.

In general, wet type image forming apparatuses are provided with a fixing section 5 including a heating roller 51 and a pressure roller 52 between the secondary transfer section 4 and the ejection section 6, as indicated by the imaginary lines in the drawing. The heating roller 51 and the pressure roller 52 face each other so as to nip a recording medium for the purpose of fixing a transferred image to the recording medium.

However, the wet type image forming apparatus 1A used in the image forming method using the liquid developer according to the present disclosure is not provided with such a fixing section 5. The wet type image forming apparatus 1A is provided with a pair of rollers 8 used for mere conveyance of a recording medium in lieu of the fixing section 5. That is, the wet type image forming apparatus 1A according to the present embodiment uses the liquid developer according to the first embodiment to achieve fixing of an image transferred to a recording medium to a recording medium without providing thermal energy and optical energy by the fixing section to the recording medium. In other words, the image forming method according to the second embodiment can eliminate the need of the generally employed fixing section 5 that employs thermal or optical energy. Accordingly, the image forming method according to the second embodiment can simplify the structure of the wet type image forming apparatus 1A, thereby achieving reduction in material cost and assembly cost of the wet type image forming apparatus 1A.

The image forming section 2 includes an intermediate transfer belt 21, a cleaning section 22 for the intermediate transfer belt 21, and a black (Bk) image forming unit FB.

The intermediate transfer belt 21 is a wide conductive endless belt member. The intermediate transfer belt 21 is driven to rotate in the clockwise direction in FIG. 1. As to the rotation of the intermediate transfer belt 21, the surface of the intermediate transfer belt 21 facing outward is referred to as an “obverse surface”, while the surface thereof facing inward is referred to as a “reverse surface”.

The image forming unit FB includes a photosensitive drum 10, an electrostatic charger 11, an LED exposure device 12, a liquid development device 14, a primary transfer roller 20, a cleaning device 26, and a static eliminator 13.

The obverse surface (peripheral surface) of the columnar photosensitive drum 10 is capable of bearing an image visualized with charged colored particles. The photosensitive drum 10 shown is capable of rotating in the anticlockwise direction.

The electrostatic charger 11 uniformly charges the obverse surface of the photosensitive drum 10. The operation of the electrostatic charger 11 corresponds to electrostatically charging.

The LED exposure device 12 includes an LED as a light source. The LED exposure device 12 irradiates light to the uniformly charged obverse surface of the photosensitive drum 10 on the basis of image data input from external equipment. Thus, an electrostatic latent image based on the image data is formed on the obverse surface of the photosensitive drum 10. The operation of the exposure device 12 corresponds to exposing.

The liquid development device 14 holds the liquid developer so that the liquid developer faces the electrostatic latent image formed on the surface of the photosensitive drum 10. The liquid developer includes an insulating carrier liquid and colored particles dispersed in the carrier liquid. Thus, the electrostatic latent image on the surface of the photosensitive drum 10 is visualized with the charged colored particles to be developed as an image. The operation of the liquid development device 14 corresponds to developing.

As shown in FIG. 2, the liquid development device 14 includes a developer container 140, a development roller 141, a supply roller (anilox roller) 142, a support roller 143, a supply roller blade 144, a developer cleaning blade 145, a developer collecting device 146, and a development roller charger 147.

The liquid developer is supplied to and retained in the interior of the developer container 140. The liquid developer is supplied to the interior of the developer container 140 from the supply nozzle 278 after density adjustment of the colored particles to the carrier liquid in advance. In so doing, the liquid developer is supplied toward an abutment portion between the supply roller 142 and the support roller 143. Surplus of the liquid developer falls down under the support roller 143 to be retained in the bottom of the developer container 140. The retained liquid developer is collected through a pipe 82 to be recycled and reused.

The support roller 143 is arranged at the substantial center of the developer container 140 and abuts on the supply roller 142 from below to form the abutment portion. The supply roller 142 is offset in the direction away from the supply nozzle 278, rather than being arranged immediately above the support roller 143. Grooves to hold the liquid developer are formed in the peripheral surface of the supply roller 142. As indicated by the broken arrow in FIG. 2, the support roller 143 rotates in the anticlockwise direction, while the supply roller 142 rotates in the clockwise direction.

The liquid developer supplied from the supply nozzle 278 temporarily stays on the upstream side of the abutment portion between the supply roller 142 and the support roller 143 in the rotation direction of the support roller 143. Rotation of both the rollers 142, 143 accompanies upward conveyance of the staying liquid developer with it held in the grooves in the supply roller 142. The supply roller blade 144 is in press contact with the peripheral surface of the supply roller 142 for restriction by scraping surplus liquid developer so that the amount of the liquid developer held in the grooves in the supply roller 142 to be a predetermined amount. The surplus liquid developer scraped off by the supply roller blade 144 is retained in the bottom of the developer container 140.

The development roller 141 is arranged at the upper opening of the developer container 140 so as to be in contact with the supply roller 142. The development roller 141 rotates in the same direction as the supply roller 142. Accordingly, the surface of the development roller 141 moves in the direction reverse to the direction in which the surface of the supply roller 142 moves in the abutment portion where the development roller 141 abuts on the supply roller 142. Thus, the liquid developer held on the peripheral surface of the supply roller 142 is delivered to the peripheral surface of the development roller 141. The amount of the liquid developer held in the grooves of the supply roller 142 (thickness of a thin layer of the liquid developer) is restricted to the predetermined value. This means that the amount of the liquid developer held on the surface of the development roller 141 (thickness of a thin layer of the liquid developer) is also kept at the predetermined value.

The development roller charger 147 provides bias potential having the same polarity as the charging polarity of the colored particles to the development roller 141 from the outer surface of the development roller 141 (developing corona charge). Accordingly, the development roller charger 147 moves the colored particles in the thin layer of the liquid developer held on the surface of the development roller 141 toward the surface of the development roller 141. Thus, the colored particles in the thin layer of the liquid developer are gathered and compressed (compaction) on the surface side of the development roller 141 by the operation of an electric field, thereby forming a high density layer of the colored particles on the surface side of the development roller 141. Thereafter, the thin layer of the liquid developer is supplied to the photosensitive drum 10, thereby developing an electrostatic latent image on the photosensitive drum 10. Thus, a high-definition image of which development efficiency is increased can be formed. The development roller charger 147 is arranged downstream in the rotation direction of the development roller 141 away from the contact portion between the development roller 141 and the supply roller 142 and upstream in the rotation direction of the development roller 141 away from the contact portion between the development roller 141 and the photosensitive drum 10 so as to face the peripheral surface of the development roller 141. That is, the development roller charger 147 generates the electric field by the developing corona charge. In this manner, the thin layer of the liquid developer on the development roller 141 is separated into two layers, that is, a layer of the colored particles on the surface of the development roller 141 and a layer of the carrier liquid on the layer of the colored particles. Thus, the thin layer of the liquid developer on the development roller 141 comes in contact with the surface of the photosensitive drum 10 in a development region (a contact region between the development roller 141 and the photosensitive drum 10 and its peripheral region) in the state of the tow layers. At this time, the colored particles gathered and compressed on the surface side of the development roller 141 move from the surface of the development roller 141 to the surface of photosensitive drum 10 in accordance with the principle of electrophoresis, thereby visualizing an electrostatic latent image on the surface of the photosensitive drum 10 as an image. By the developing corona charge by the development roller charger 147, the colored particles in the thin layer of the liquid developer on the development roller 141 are compressed (compaction) on the surface of the development roller 141 before development. For this reason, the colored particles are out of contact with a non-image region on the photosensitive drum 10. This can prevent fogging in the formed image. Further, by the electric field formed by the developing corona charge, the electric charge is injected to the colored particles in the thin layer of the liquid developer on the development roller 141. Accordingly, the colored particles can be developed on an electrostatic latent image on the photosensitive drum 10 excellently with the development field. Also, the colored particles can be electrostatically firmly attached to the surface of the photosensitive drum 10.

The development roller 141 is in contact with the photosensitive drum 10. With the potential difference between the electrostatic latent image on the surface of the photosensitive drum 10 and the development filed applied to the development roller 141, an image based on image data is formed on the surface of the photosensitive drum 10.

The developer cleaning blade 145 is arranged so as to be in contact with a portion of the development roller 141, which is located downstream in the rotation direction of the development roller 141 away from a contact portion with the photosensitive drum 10. The developer cleaning blade 145 removes residual liquid developer on the surface of the development roller 141, which has performed the development operation on the photosensitive drum 10.

The developer collecting device 146 collects the liquid developer removed by the developer cleaning blade 145 and sends out the liquid developer to the pipe 81 of a liquid developer circulating device. The liquid developer flows down along the surface of the developer cleaning blade 145. Since the viscosity of the liquid developer is high, the developer collecting device 146 includes a delivery roller for assistance of the delivery of the liquid developer.

The primary transfer roller 20 is arranged on the reverse surface of the intermediate transfer belt 21 to face the photosensitive drum 10. Voltage with a polarity reverse to that of the colored particles in an image is applied to the primary transfer roller 20 from the power source (not shown). At a portion in contact with the intermediate transfer belt 21, the primary transfer roller 20 applies the voltage with a polarity reverse to that of the colored particles to the intermediate transfer belt 21. The intermediate transfer belt 21 is conductive. The voltage application causes the colored particles to be attracted to the obverse surface of the intermediate transfer belt 21 and its periphery. That is, the image developed on the surface of the photosensitive drum 10 is transferred to the intermediate transfer belt 21. The intermediate transfer belt 21 bears the image to function as an image bearing member for conveyance to a recording medium.

The cleaning device 26 is a device to clean residual liquid developer not transferred from the photosensitive drum 10 to the intermediate transfer belt 21. The cleaning device 26 includes a residual developer conveyance screw 261 and a cleaning blade 262. The residual developer conveyance screw 261 arranged in the interior of the cleaning device 26 conveys the residual developer, which is scraped off by the cleaning blade 262 and accommodated in the cleaning device 26, to the exterior of the cleaning device 26.

The plate-shaped cleaning blade 262 extends in the direction of the rotational axis of the photosensitive drum 10 to scrape off liquid developer remaining on the surface of the photosensitive drum 10. One end part of the cleaning blade 262 is in slide contact with the surface of the photosensitive drum 10. Accompanied by rotation of the photosensitive drum 10, the end part thereof scrapes off the liquid developer remaining on the photosensitive drum 10.

The static eliminator 13 includes a light source for static elimination. For preparation for image formation in the next round, the static eliminator 13 eliminates static on the surface of the photosensitive drum 10 with the use of the light from the light source after the cleaning blade 262 removes the residual liquid developer.

The recording medium accommodating section 3 shown in FIG. 1 accommodates a recording medium, to the surface of which an image is fixed and formed. The recording medium accommodating section 3 is arranged in the lower part of the wet type image forming apparatus 1A. Further, the recording medium accommodating section 3 includes a paper feed cassette (not shown) capable of accommodating a recording medium.

The secondary transfer section 4 transfers the image formed on the intermediate transfer belt 21 to a recording medium. The secondary transfer section 4 includes a support roller 41 to support the intermediate transfer belt 21 and a secondary transfer roller 42 arranged to face the support roller 41. It is noted that the secondary transfer section 4, the primary transfer roller 20, and the intermediate transfer belt 21 form a transfer device in the present embodiment. The operation of the secondary transfer section 4 and the operation of the primary transfer roller 20 correspond to transferring.

As described above, a pair of conveyance rollers 8 is provided above the secondary transfer section 4 in lieu of the fixing section 5.

The recording medium to which the image have been transferred and fixed is ejected onto the ejection section 6 provided on the top surface of the wet type image forming apparatus 1A. The recording medium conveyance section 7 includes a plurality of conveyance roller pairs and conveys a recording medium from the recording medium accommodating section 3 to the ejection section 6 via the secondary transfer section 4. The operation that the recording medium conveyance section 7 ejects a recording medium, to which an image has been transferred, to the ejection section 6 correspond to ejecting.

According to the above described image forming method in the second embodiment, an image forming method including given steps and using a liquid developer employs the liquid developer according to the first embodiment as the liquid developer. This can favorably fix the colored particles to a recording medium, while reducing consumption of thermal or optical energy in fixing the colored particles to the recording medium, thereby forming an image with desired image density. Accordingly, the image forming method of the second embodiment can be suitably employed in various types of wet type image forming apparatuses.

### EXAMPLES

The present disclosure will be described below further in detail with reference to the following examples. It is noted that the present disclosure is not limited to the following examples.

### Preparation Example 1

### Preparation of Organic Macromolecular Compound Solutions A-F

15 mass % of the following types of a copolymer resin and 85 mass % of a carrier liquid (liquid paraffin, MORESCO WHITE (registered trademark) P55 (by MORESCO Corporation)) as a solvent were put into a 1000-ml three-neck flask including a cooling pipe (Liebig condenser), a thermometer, and a stirring rod (NR-43 (rabble (with vane) entirely coated with Teflon (registered trademark)). Then, the content in the flask was stirred at a stirring rate of 250 rpm, while the temperature of the content is increased up to 160° C. at a rate of 7° C./min. with the use of an oil bath. After the temperature of the content was increased up to 160° C., 8-hour stirring of the content at the same temperature was performed, thereby obtaining respective organic macromolecular compound solutions containing the following types of a copolymer resin.

For preparation of the respective organic macromolecular compound solutions A-F, the following types of a copolymer resin were used.

Organic macromolecular compound solution A: styrene-based elastomer (SBS) (Asaprene (registered trademark) T413 (by Asahi Kasei Chemicals Corp.))
Organic macromolecular compound solution B: styrene-based elastomer (SBS) (Tufprene (registered trademark) 125 (by Asahi Kasei Chemicals Corp.))
Organic macromolecular compound solution C: styrene-based elastomer (SBS) (Tufprene (registered trademark) 315P (by Asahi Kasei Chemicals Corp.))
Organic macromolecular compound solution D: styrene-based elastomer (SEBS) (ARON AR-710 (by ARONKASEI CO., LTD.))
Organic macromolecular compound solution E: styrene-based elastomer (SBC) (RABALON (registered trademark) SJ4300C (by Mitsubishi Chemical Corporation))
Organic macromolecular compound solution F: cyclic olefin copolymer (TOPAS (registered trademark) TM (by TOPAS Advanced Polymers GmbH))

### Preparation Example 2

### Preparation of Colored Particles A

50 parts by mass of a polyester resin (acid value: 15 mgKOH/g, Tm: 85° C.) and 50 parts by mass of carbon black (MA100 (by Mitsubishi Chemical Corporation)) were mixed using a Henschel mixer (FM-20B (by NIPPON COKE & ENGINEERING CO., LTD.)). The obtained mixture was melted and kneaded by a two-axis screw extruder (PCM-30 (by IKEGAI KK)). The obtained kneaded substance was pulverized using a jet mill (IDS-2 (by NIPPON PNEUMATIC MFG. CO. LTD.)). The particles after the pulverizing were classified using an airflow type classifier (ATP (by Hosokawa Micron Corporation)), thereby obtaining colored particles A with a volume average particle diameter (D₅₀) of 6 μm. It is noted that the volume average particle diameter (D₅₀) was measured using a coulter counter (Multisizer 3 (by Beckman Coulter, Inc.)). It is noted that Tm in the present specification means a softening point.

### (Preparation of Colored Particles B)

Colored particles B with a volume average diameter (D₅₀) of 6.3 μm were obtained in the same manner as the colored particles A except that a styrene acrylic resin (acid value: 0.3 mgKOH/g or smaller, Tm: 110° C.) was used in lieu of a polyester resin.

### Preparation Example 3

### Preparation of Concentrated Developers A-E

Putting into a ball mill (Universal Ball Mill Model UB32 (by Yamato Scientific Co., Ltd.)) were respective types and amount listed in Table 1 of colored particles, the respective amounts listed in Table 1 of a carrier liquid (liquid paraffin, MORESCO WHITE (registered trademark) P55 (by MORESCO CORPORATION)), and the respective amounts listed in Table 1 of a dispersant (ANTARON V-216 (by ISP Japan Ltd.)). Then, they were mixed and dispersed for 96 hours at a rotation rate of 100 rpm, thereby obtaining respective concentrated developers A-E.

TABLE 1

| | | Composition (mass %) | | |
|---|---|---|---|---|
| Concentrated | Types of | Colored | Carrier | |
| developer | colored particles | particles | liquid | Dispersant |
| A | A | 40 | 44 | 16 |
| B | A | 40 | 52 | 8 |
| C | A | 40 | 56 | 4 |
| D | B | 40 | 56 | 4 |
| E | A | 40 | 40 | 20 |

### Examples 1-9 and Comparative Examples 1 and 2

### Preparation of Liquid Developer

Putting into a homomixier (T. K. HOMO MIXER MARK II Model 2.5 (by PRIMIX Corporation)) were 25 mass % of concentrated developers of respective types listed in Table 2, 33.3 mass % of the respective organic macromolecular compound solutions listed in Table 2, and 41.7 mass % of a carrier liquid (liquid paraffin, MORESCO WHITE (registered trademark) P55 (by MORESCO CORPORATION)). Then, they were mixed for 5 minutes at a rotation rate of 12,000 rpm, thereby obtaining liquid developers of Examples 1-9 and Comparative Example 2.

25 mass % of the concentrated developer listed in Table 2 and 75 mass % of a carrier liquid (liquid paraffin, MORESCO WHITE (registered trademark) P55 (by MORESCO CORPORATION)) were mixed using a homomixer by the above method, thereby obtaining a liquid developer of Comparative Example 1.

Each volume average particle diameter (D₅₀) of the respective types of colored particles in the liquid developer obtained in Examples and Comparative Examples was measured. Table 2 indicates the measurement results of the volume average particle diameter (D₅₀) of each type of the colored particles in the liquid developer. It is noted that the volume average particle diameter (D₅₀) was measured using a laser diffraction particle size analyzer (Mastersizer 2000 (by Malvern Instruments Ltd)).

TABLE 2

| | | Type of organic | |
|---|---|---|---|
| | Type of | macromolecular | Volume average |
| | concentrated | compound | particle diameter |
| | developer | solution | (D₅₀) [μm] |
| Example 1 | A | A | 0.43 |
| Example 2 | B | A | 0.65 |
| Example 3 | B | B | 0.67 |
| Example 4 | B | C | 0.71 |
| Example 5 | B | D | 0.59 |
| Example 6 | B | E | 0.67 |
| Example 7 | B | F | 0.73 |
| Example 8 | C | F | 1.25 |
| Example 9 | D | F | 0.86 |
| Comparative | A | — | 0.42 |
| Example 1 | | | |
| Comparative | E | A | 0.31 |
| Example 2 | | | |

### Comparative Examples 3 and 4

Treatment using a high pressure homogenizer (NANO3000 (by Sojitz Machinery Corporation)) was performed five times on 10 mass % of colored particles of respective types listed in Table 3, 33.3 mass % of the organic macromolecular compound solution A, and 56.7 mass % of a carrier liquid (liquid paraffin, MORESCO WHITE (registered trademark) P55 (by MORESCO CORPORATION)), thereby obtaining liquid developers of Comparative Examples 3 and 4. Each volume average particle diameter (D₅₀) of the respective types of colored particles in the liquid developer obtained in Comparative Examples 3 and 4 was measured. Table 3 indicates the measurement results of the volume average particle diameter (D₅₀) of each type of the colored particles in the liquid developer obtained in Comparative Examples 3 and 4.

The conditions of the high pressure homogenizer in preparing the liquid developer were as follows.

Temperature of raw material: 110° C.
Ejection of raw material: 200 MPa (G)
Diameter of first nozzle: 0.11 μm
Diameter of second nozzle: 0.19 μm
Temperature of cooling chiller water: 5° C.

### Depressurization Method: Depressurization Cell (Multistage Depressurization Module)

TABLE 3

| | | Type of organic | |
|---|---|---|---|
| | Type of | macromolecular | Volume average |
| | colored | compound | particle diameter |
| | particles | solution | (D₅₀) [μm] |
| Comparative | A | A | 0.45 |
| Example 3 | | | |
| Comparative | B | A | 0.22 |
| Example 4 | | | |

### <<Evaluation>>

According to the following method, fixability evaluation and developability evaluation were performed on the liquid developers obtained in Examples 1-9 and Comparative Examples 1-4 by using the wet type image forming apparatus with no fixing section. Evaluation results are indicated in Table. 4. Further, Table 4 indicates the content (OP) [mass %] of each organic macromolecular compound in the liquid developer, the content (V) [mass %] of each dispersant in the liquid developer, and each mass ratio (V/OP) therebetween.

### <Image Forming Method>

An image was formed using the monochrome printer 1A (experimental unit by KYOCERA Document Solutions Inc., linear velocity: 116 mm/sec.) as a wet type image forming apparatus with no fixing section. The respective liquid developers were introduced into an image forming unit FB of the printer 1A. Using printing paper (paper dedicated for wet development, EP-L (by Mitsubishi Paper Mills Ltd.)) as a recording medium, a uniformly filled square solid image (5 cm×5 cm) was formed on a recording medium, which corresponds to a pigment placement amount of 0.026 mg/cm². In forming the image, the thickness of the layer of each liquid developer on the peripheral surface of the development roller was set to be 3 μm. Further, in forming an image based on image data on the surface of the photosensitive drum, the development field applied to the development roller was set at 400 V. The other conditions for image formation are listed as follows.

Bias potential of developing corona charge by the development roller charger 147: 4000 V
Material for the intermediate transfer belt 21: polyimide
Dark potential of the photosensitive drum 10: +550 V
Light potential of the photosensitive drum 10: +10 V
Primary transfer voltage of the primary transfer roller 20: 300 V (constant voltage control)
Secondary transfer current applied to the secondary transfer roller 42: 40 μA (constant current control)

### (Develop Ability Evaluation)

A rubbing test for the developability evaluation was performed on part of each solid image obtained when the solid image is transferred from the secondary transfer section to a recording medium, and the recording medium was ejected onto the ejection section. That is, the rubbing test was performed on the recording medium after five seconds from transfer of the solid image from the secondary transfer section. The rubbing test was performed in a manner that a metal weight rubs the solid image reciprocally ten times. The metal weight used had a columnar shape, of which bottom was covered with cloth, with a mass of 1 kg and a diameter of 50 mm. The image density of each solid image after the rubbing test was measured using a spectrodensitometer (X-Rite SpectroEye (by GretagMacbet)). The developability was evaluated with reference to the following references.

very good: image density is 1. 2 or higher.
good: image density is 1.0 or higher and below 1.2.
poor: image density is below 1.0.

### (Fixability Evaluation)

The image density of non-imaged portion around the solid image of each recording medium after the rubbing test, which was obtained in the develpability evaluation, was measured. For the measurement of the image density, a spectrodensitometer (X-Rite SpectroEye (by GretagMacbet)) was used. Next, the image density of non-used printing paper was measured. A difference in image density between the non-imaged portion around the solid image and the non-used printing paper was calculated as the density of the non-imaged portion. The fixability evaluation was performed with reference to the following references.

good: density at non-imaged part is below 0.02.
poor: density at non-imaged part is 0.02 or higher.

TABLE 4

| | Composition of liquid developer | | | | | | |
|---|---|---|---|---|---|---|---|
| | Content (OP) of | | | Developability | | | |
| | organic | Content (V) | evaluation | Fixity evaluation | | | |
| | macromolecular | of | | Image | | Density of | |
| | compound | dispersant | Mass ratio | density of | | non-imaged | |
| | [mass %] | [mass %] | (V/OP) | solid image | Evaluation | portion | Evaluation |
| Example 1 | 5 | 4 | 0.8 | 1.4 | very good | 0.010 | good |
| Example 2 | 5 | 2 | 0.4 | 1.3 | very good | 0.013 | good |
| Example 3 | 5 | 2 | 0.4 | 1.3 | very good | 0.011 | good |
| Example 4 | 5 | 2 | 0.4 | 1.3 | very good | 0.008 | good |
| Example 5 | 5 | 2 | 0.4 | 1.3 | very good | 0.013 | good |
| Example 6 | 5 | 2 | 0.4 | 1.3 | very good | 0.012 | good |
| Example 7 | 5 | 2 | 0.4 | 1.3 | very good | 0.014 | good |
| Example 8 | 5 | 1 | 0.2 | 1.1 | good | 0.012 | good |
| Example 9 | 5 | 1 | 0.2 | 1.1 | good | 0.008 | good |
| Comparative | — | 5 | — | 1.5 | very good | 0.188 | poor |
| Example 1 | | | | | | | |
| Comparative | 5 | 5 | 1 | 1.5 | very good | 0.023 | poor |
| Example 2 | | | | | | | |
| Comparative | 5 | — | — | 0.8 | poor | 0.005 | good |
| Example 3 | | | | | | | |
| Comparative | 5 | — | — | 0.9 | poor | 0.002 | good |
| Example 4 | | | | | | | |

Each liquid developer obtained in Examples 1-9 contained an insulating carrier liquid, colored particles each including a binder resin and carbon black, an organic macromolecular compound formed of a copolymer resin selected from cyclic olefin copolymers and styrene-based elastomers, and a dispersant. The organic macromolecular compound was dissolved in the carrier liquid. The mass ratio (V/OP) of the content (V) of the dispersant in the liquid developer to the content (OP) of the organic macromolecular compound in the liquid developer was within the predetermined range. It is understood that with each liquid developer obtained in Examples 1-9, even by the image forming apparatus including no fixing section so as to employ neither thermal energy nor optical energy in fixing the colored particles to a recording medium, an image with desired image density can be formed on a recording medium. Also the colored particles can be fixed favorably to a recording medium.

The liquid developer obtained in Comparative Example 1 included no organic macromolecular compound. It is understood that with the liquid developer obtained in Comparative Example 1, it is difficult to fix the colored particles to a recording medium. This might be because no film of an organic macromolecular compound is formed on the colored particles.

The liquid developer obtained in Comparative Example 2 contained an organic macromolecular compound and a dispersant. However, the mass ratio (V/OP) of the content (V) of the dispersant in the liquid developer to the content (OP) of the organic macromolecular compound in the liquid developer was excessive. It is understood that with the liquid developer obtained in Comparative Example 2, it is difficult to form an image with desired image density on a recording medium. This might be because a too large ratio of V to OP made it difficult to favorably form a film of the organic macromolecular compound on the colored particles on a recording medium, thereby impairing the fixability of the colored particles.

Each liquid developer obtained in Comparative Examples 3 and 4 included no dispersant. It is understood that the liquid developers obtained in Comparative Examples 3 and 4 made it difficult to form an image with desired image density. This might be because discharge from the carbon black exposed to the surfaces of the colored particles is difficult to reduce, thereby resulting in an unstable charge state of the colored particles.

What is claimed is:

1. A liquid developer comprising:
an insulating carrier liquid; colored particles; an organic macromolecular compound; and a dispersant, wherein
the organic macromolecular compound is dissolved in the carrier liquid,
the organic macromolecular compound is formed of a copolymer resin selected from cyclic olefin copolymers and styrene-based elastomers,
the colored particles are dispersed in the carrier liquid,
each of the colored particles includes a binder resin and carbon black, and
a mass ratio (V/OP) of a content (V) of the dispersant in the liquid developer to a content (OP) of the organic macromolecular compound in the liquid developer is 0.2 or larger and 0.8 or smaller.

2. A liquid developer according to claim 1, wherein
the binder resin is a styrene-acrylic copolymer.

3. A liquid developer according to claim 1, wherein
the cyclic olefin copolymer(s) is a copolymer of norbornene and ethylene or a copolymer of tetracyclododecene and ethylene.

4. A liquid developer according to claim 1, wherein
the styrene-based elastomer(s) is a styrene-butadiene-based elastomer.

5. An image forming method employing a wet development process comprising:
electrostatically charging a surface of a photosensitive drum;
exposing the electrostatically charged surface of the photosensitive drum to form an electrostatic latent image on the surface of the photosensitive drum;
developing the electrostatic latent image on the surface of the photosensitive drum with the use of a liquid developer according to the claim 1;
transferring the developed image to a recording medium; and
ejecting the recording medium to which the image is transferred to an ejection section.

6. A wet type image forming apparatus for forming an image with the use of a liquid developer, comprising:
an image forming section, a recording medium accommodating section, a secondary transfer section, an ejection section, a recording medium conveyance section, and a pair of recording medium conveyance rollers used only for conveyance of a recording medium,
wherein the pair of recording medium conveyance rollers are arranged between the secondary transfer section and the ejection section.
